(19) United States
(12) Patent Application Publication
(10) Pub. No.: US 2010/0333215 A1
(43) Pub. Date: Dec. 30, 2010

(54) ELECTRONIC DEVICE WITH STYLUS

(75) Inventors: Kui-Jun Wang, Shenzhen City (CN); Feng-Xiang Tang, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HON FU JIN PRECISION INDUSTRY (ShenZhen) CO., LTD., ShenZhen City (CN); HON HAI PRECISION INDUSTRY CO., LTD., Tu-Cheng (TW)

(21) Appl. No.: 12/547,502

(22) Filed: Aug. 26, 2009

(30) Foreign Application Priority Data
Jun. 26, 2009 (CN) 200910303742.0

(51) Int. Cl. G06F 21/00

(52) U.S. Cl. 726/34

(57) ABSTRACT

An electronic device comprising: a main body and a stylus, wherein the main body comprises: a trigger, which is assigned identification information; a socket configured for receiving the stylus, wherein the socket defines a grooves on an inner surface thereof, and the grooves is configured for placement a trigger; and a processing unit configured for recognizing the identification information of the trigger to determine whether to lock or unlock the electronic device; the stylus comprises: a shank and a ring, wherein the ring is extended from the circumferential surface of the shank, a hook is formed in an end of the stylus, and a protrusion is protruded from the circumferential surface of the ring in alignment with the hook and is received in the groove to press the trigger when the stylus is inserted into the socket and the hook is aligned with the trigger.

### BACKGROUND

1. Technical Field

The present disclosure relates to an electronic device with a stylus.

2. Description of Related Art

Generally, users can press one or more keys on a keyboard of an electronic device to make the electronic device enter a locked state. However, some users with poor eyesight may easily press the wrong keys and find it difficult to lock or unlock the electronic device.

Therefore, what is need is an electronic device which can be easily locked and unlocked.

### BRIEF DESCRIPTION OF THE DRAWINGS

FIG. 1 is an isometric view of an electronic device in accordance with an exemplary embodiment.

FIG. 2 is a block diagram of a hardware infrastructure of the electronic device of FIG. 1.

FIG. 3 is a partial, exploded view of the electronic device of FIG. 1.

FIG. 4 is a magnified view of a shank of the electronic device of FIG. 3.

FIG. 5 is a sectional view of a pen socket included in the electronic device of FIG. 1.

FIG. 6 is a schematic diagram of the electronic device of FIG. 1 in an unlocked state.

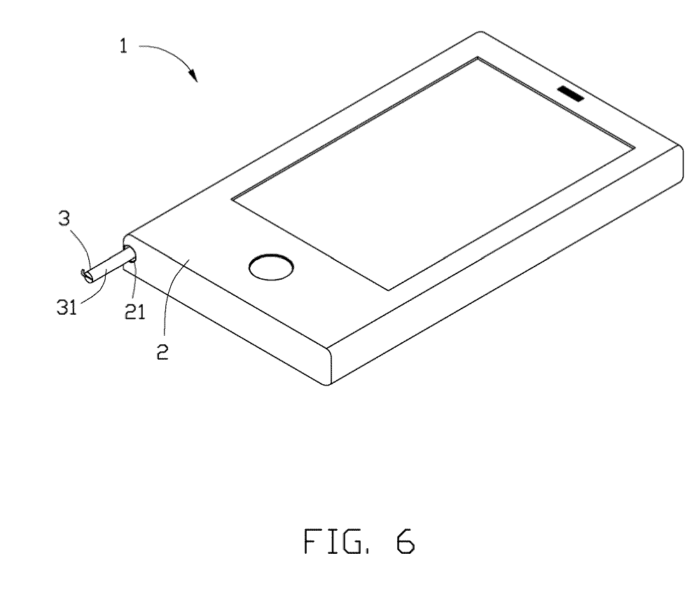

### DETAILED DESCRIPTION

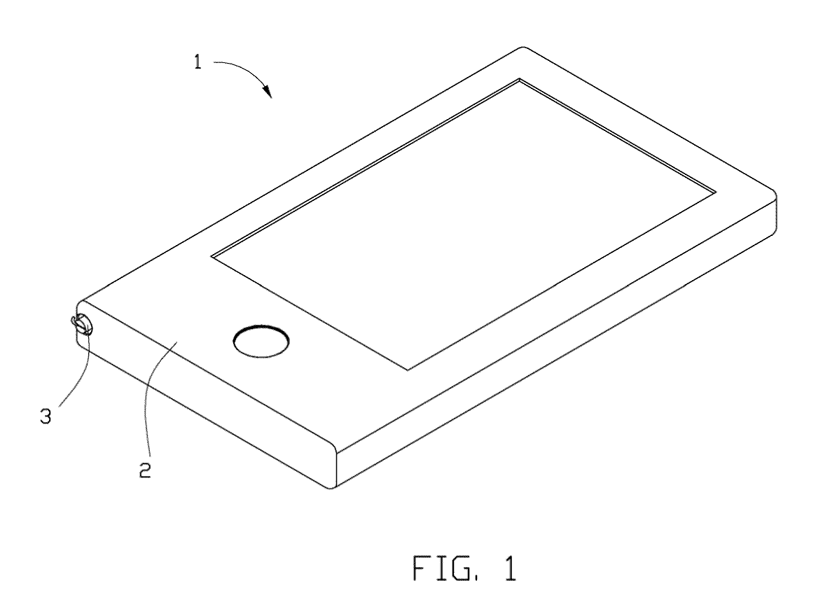

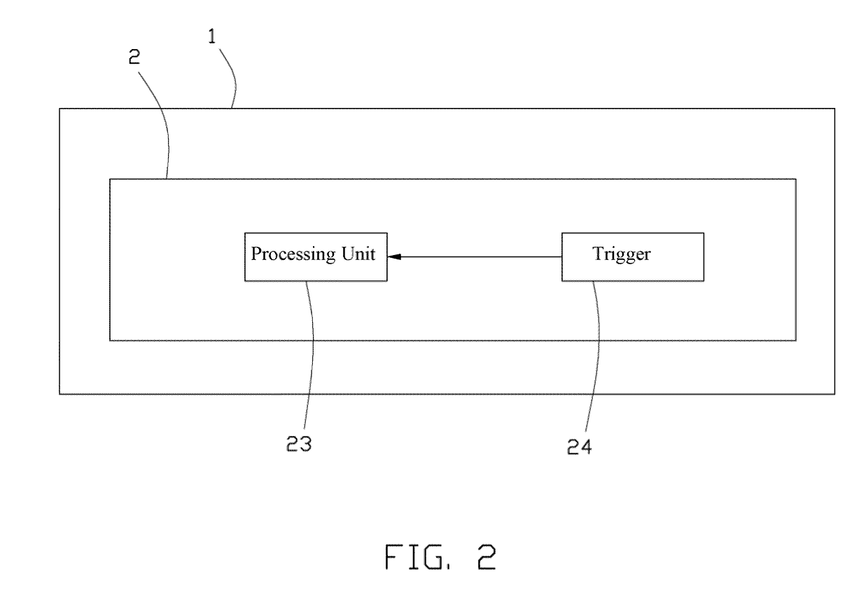

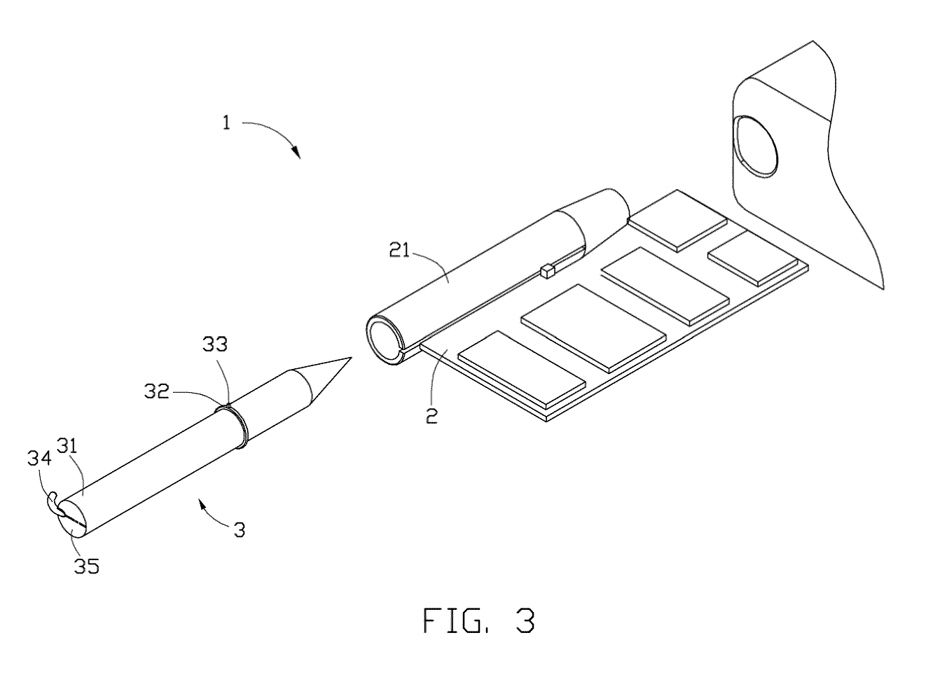

Referring to FIGS. 1-3, an electronic device 1 includes a main body 2 and a stylus 3. The main body 2 includes a socket 21, a processing unit 23, and a trigger 24. The socket 21 is a hollow cylinder formed in a side plate of the electronic device 1. The socket 21 is configured for receiving the stylus 3. The trigger 24 is electronically connected to the processing unit 23, and is assigned identification information. The processing unit 23 is configured for recognizing the identification information of the trigger 24 to determine whether to lock or unlock the electronic device 1.

The stylus 3 includes a cylindrical shank 31. A ring 32 is extended from the circumferential surface of the shank 31. A protrusion such as a hook 34 is formed in an end 35 away from a point of the stylus 3. The ring 32 is made from elastic material. A non-elastic protrusion 33 is protruded from the circumferential surface of the ring 32 in alignment with the hook 34. In other embodiments, the protrusion 33 is made from elastic material and the ring 32 is not elastic.

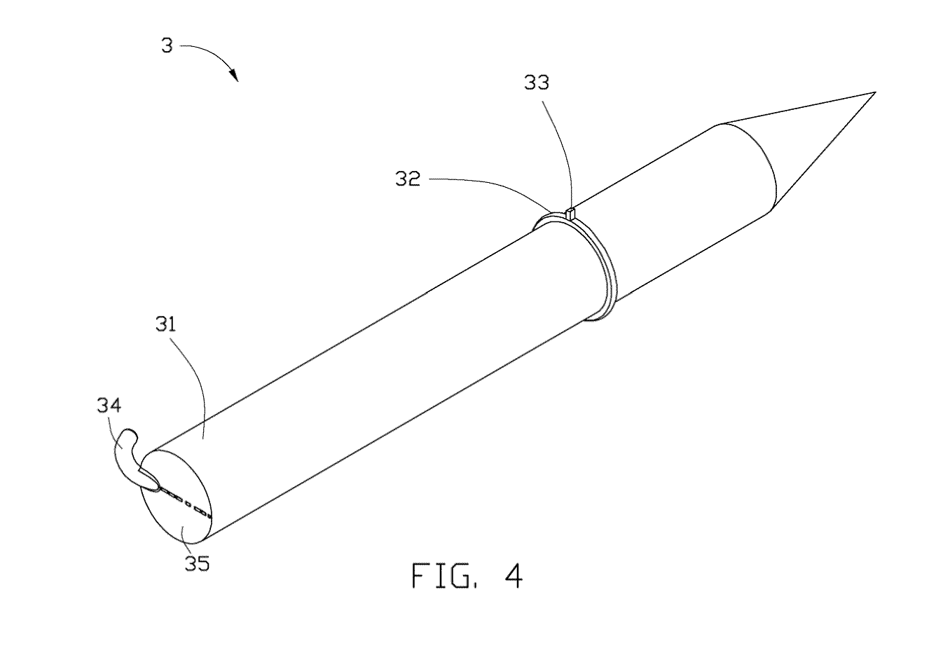

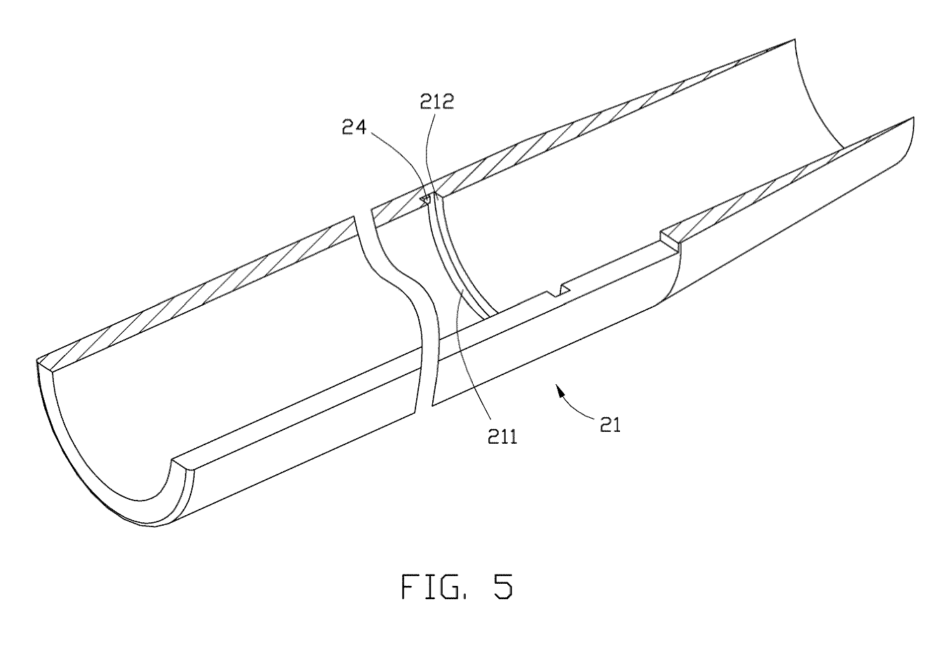

Referring to FIGS. 4 and 5, a groove 211 is formed in the inner surface of the socket 21, and is configured for receiving the ring 32. A groove 212 is formed in a bottom surface of the groove 211. The groove 212 is configured for placement of a trigger 24 therein and configured for receiving the protrusion 33. The trigger 24 will be pressed by the protrusion 33 when the hook 34 is aligned with the trigger 24 which can be indicated to the user via a mark on the main body 2 or via engagement with a portion of the main body 2 such as a notch (not shown). In other words the user can insert the stylus 3 into the socket 21 then rotate the stylus manually until the hook 34 is aligned with the trigger 24.

In some other embodiments, the groove 212 may be directly formed in the inner surface of the socket 21, and the groove 211 omitted.

The electronic device 1 can be kept in a locked state and a unlocked state. When the electronic device 1 is in the locked state, the processing unit 23 does not receive any data or commands entered with the stylus 3 on a touch pad or through input keys (not shown). When the electronic device is in the unlocked state, the processing unit 23 can receive data or commands.

When the electronic device 1 is in the unlocked state, but a user wants to lock the electronic device 1, the user inserts the stylus 3 into the socket 21, and rotates the stylus 3 manually until the hook 34 is aligned with the trigger 24, the trigger 24 is pressed by the protrusion 33. The processing unit 23 recognizes the identification information of the pressed trigger 24 and locks the electronic device 1. If the stylus 3 is inserted into the socket 21, but the hook 34 is not aligned with the trigger 24, then the trigger 24 is not pressed and the electronic device 1 remains unlocked.

When the electronic device 1 is in the locked state, and the user want to use the electronic device 1, the user removes the stylus 3 from socket 21; the trigger 24 is released and the electronic device 1 becomes unlocked. After the electronic device 1 is unlocked, the user can use the stylus 3 for entering data or commands to the electronic device 1. In the exemplary embodiment, the trigger 24 is a pressure sensor. In other embodiments, the trigger 24 may be a trigger switch, etc.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device comprising:
a main body and a stylus, wherein
the main body comprises:
a trigger, which is assigned identification information;
a socket configured for receiving the stylus, wherein the socket defines a groove on an inner surface thereof, and the groove is configured for placement a trigger; and
a processing unit configured for recognizing the identification information of the trigger to determine whether to lock or unlock the electronic device;
the stylus comprises:
a shank and a ring, wherein the ring is extended from the circumferential surface of the shank, a hook is formed in an end of the stylus, and a protrusion is protruded from the circumferential surface of the ring in alignment with the hook and is received in the groove to press the trigger when the stylus is inserted into the socket and the hook is aligned with the trigger;
wherein, when the processing unit recognizes the identification information of the pressed trigger, it locks the electronic device.

2. The electronic device as described in claim 1, wherein when the electronic device is in an unlocked state and the stylus is inserted into the socket, with no trigger being pressed, the electronic device remains unlocked.

3. The electronic device as described in claim 1, wherein when the electronic device is in a locked state and the stylus is removed from the socket, the trigger is released and the electronic device becomes unlocked.

4. The electronic device as described in claim 1, wherein a ring-shaped groove is formed on the inner surface of the socket, and configured for receiving the ring; a groove for receiving the protrusion is formed on a bottom surface of the ring-shaped groove.

5. The electronic device as described in claim 1, wherein the trigger is a pressure sensor.

6. The electronic device as described in claim 1, wherein the trigger is a trigger switch.

7. The electronic device as described in claim 1, wherein at least one of the ring and the protrusion is elastic.
